(19) United States
(12) Patent Application Publication
(10) Pub. No.: US 2023/0163610 A1
(43) Pub. Date: May 25, 2023

(54) METHOD FOR OPERATING A DEVICE FOR SUPPLYING OR DISCHARGING ELECTRICAL ENERGY

(71) Applicant: BETTERIES AMPS GMBH, Berlin (DE)

(72) Inventors: Joscha WINZER, Berlin (DE); José Alfonso HERNÁNDEZ RAMÍREZ, Berlin (DE)

(21) Appl. No.: 17/919,196

(22) PCT Filed: Apr. 9, 2021
(86) PCT No.: PCT/EP2021/059261

§ 371 Date: Oct. 14, 2022

(30) Foreign Application Priority Data
Apr. 15, 2020 (LU) LU101735

(51) Int. Cl. H02J 7/00; H02J 7/34; H01M 10/46

(52) U.S. Cl. CPC H02J 7/0045; H02J 7/342; H02J 7/00032; H02J 7/0013; H01M 10/46; H01M 2010/4278

(57) ABSTRACT

The invention relates to a method for operating a device for supplying or discharging electrical energy, which has a control device. At least one module of the device (1) is releasably electrically connected to a battery module (3) which has a large number of battery cells (4) and a battery module control device (5) for controlling and/or regulating the battery cells (4), wherein the control device (2) controls and/or regulates the battery module control device (5).

The invention relates to a method for operating a device for supplying or discharging electrical energy. In addition, the invention relates to a battery module and a device for supplying or discharging electrical energy, which can be electrically connected to a battery module.

Storage units for storing electrical energy, which are used in a large number of possible applications, are known from the prior art. The use of storage units in electric vehicles is known. In addition, the use of storage units for the decentralized power supply of buildings, for example, is known. In both designs, the electrical energy stored in the storage units can be delivered to consumers.

However, the known designs are permanently installed, for example in the vehicle and/or building, and are therefore not available for other applications. In addition, the number of storage units is matched to the electrical energy and power required by the consumer. However, the required electrical energy and power can fluctuate, so that the storage units are often over- or undersized.

The object of the invention is therefore to specify a method for operating a device for supplying or discharging electrical energy, in which the device can be used in a wide variety of application areas and in which the device can be adapted to the electrical energy and/or power required by the consumer.

The object is achieved by a method for operating a device for supplying or discharging electrical energy, which has a control device, wherein at least one module of the device has a battery module that has a plurality of battery cells and a battery module control device for controlling and/or regulating the battery cells, is releasably electrically connected, wherein the control device controls and/or regulates the battery module control device.

A further object of the invention is to specify a device for supplying or discharging electrical energy, in which the device can be used in a wide variety of application areas and in which the device can be adapted to the electrical energy and/or power required by the consumer.

This object is achieved by a battery module with a plurality of battery cells, a battery module control device for controlling and/or regulating the large number of battery cells, which is characterised in that the battery module has at least one connection section for releasably electrically connecting the battery module to at least one module of a device for supplying or discharging electrical energy, wherein the battery module control device can be controlled and/or regulated by a control device of the device.

According to the invention, it was recognized that the above problems can be avoided by a modular design of the device. In particular, a modular design of the device allows the device to be used in a wide variety of application areas, because the device can be adapted to the respective application area. In addition, with a modular design of the device, the electrical energy and/or power output can be easily adapted to the electrical energy and/or power required by the electrical consumer. In addition, the modular design of the device allows the device to be easily transported to the desired area of use. The device is designed in such a way that the electrical energy is selectively supplied or discharged.

According to the invention, it was recognized that a modular design can be achieved if the battery module can be releasably electrically connected to the module of the device. In particular, a control device of the module of the device is able to control and/or regulate the battery module control device of a battery module. As will be explained in more detail below, the battery module control device can control and/or regulate other battery module control devices of other battery modules. Thus, the control device can only communicate with a single battery module control device. This simplifies the structure of the device.

The device has the advantage that a control device is designed in such a way that it can control and/or regulate a battery module control device of a battery module that is electrically connected to the module of the device, without the user having to make any adjustments to the control device and/or battery module control device. The device can thus be adapted to the electrical energy and/or power required by the consumer in a simple manner, namely, in particular exclusively, by electrically connecting or disconnecting the required number of battery modules to one another. Accordingly, the device can be used in a wide variety of applications.

Within the meaning of the invention, a releasable electrical connection is understood to be an electrical connection between two components that can be released again without being destroyed. An electrical connection that can be released without the use of tools is particularly preferred. Here, the electrical connection is released solely by the user. To establish and/or release the electrical connection, the module of the device and the battery module can be moved relative to one another.

Within the meaning of the invention, a module is understood to be a functionally closed unit. The individual module components can be moved together and/or the module is connected as a whole to other components of the device or to a module of the device. The module, in particular all module components, can be connected to other components or other modules of the device by means of an interface. In this respect, a battery module is understood to be a unit that is able to store or deliver electrical energy. The battery module of the device can be electrically connected to the module of the device or to another battery module of the device via connection interfaces explained in more detail below.

The module of the device can be an application module, described in more detail below, or another battery module. The other battery module and the battery module can be of identical design. The other battery module can thus have a multiplicity of battery cells and another battery module control device for controlling and/or regulating the battery cells of the other battery module. The other battery module can be releasably electrically connected to the battery module. Only the structure of the battery module is described below. However, the other battery module has the same structure as the battery module.

The battery cells of the battery module can correspond to battery cells that have been used in drive batteries of electric vehicles. In particular, they can be battery cells whose drive batteries have been rejected because they have less than the capacity required to achieve the guaranteed range of the electric vehicle. However, such battery cells can be used in applications other than electric vehicles and therefore do not have to be disposed of.

The control device can be part of the battery module or the module of the device, in particular the application module or the other battery module.

The control and/or regulation of the battery module control device by the control device can only take place after the battery module has been electrically connected to the module of the device. Thus, before there is an electrical connection between the battery module and the module of the device, no control and/or regulation command is transmitted from the control device to the battery module control device. As already stated above, the module of the device can be the application module or another battery module.

In a particular embodiment, prior to connecting the battery module to the module of the device, the battery module may be in an idle state in which no electrical energy is output from the battery module and/or in which no electrical energy is supplied to the battery module. This offers the advantage that the risk of injury is reduced. In particular, it is avoided that the user receives an electric shock when connecting the battery module to the module of the device.

The connection section can have at least one data line of the battery module and one activation line of the battery module. The data line of the battery module can be electrically connected to another data line of the module of the device and the activation line of the battery module can be electrically connected to another activation line of the module of the device. The data line of the battery module and the activation line of the battery module can be designed in such a way that when the battery module is electrically connected to the module of the device, the data line of the battery module is electrically connected to the module of the device before the activation line of the battery module.

This can be achieved in that a connection contact of the activation line and a connection contact of the data line are of different lengths. Alternatively or additionally, a connection contact of the other data line and a connection contact of the other activation line can be of different lengths in the module of the device. As a result, it can be ensured in a simple manner that the data lines are electrically connected to one another before the activation lines.

The connection section of the battery module can have at least one power line, which is electrically connected to a power line of the module of the device, in particular at the same time as the electrical connection of the data line of the battery module to the data line of the module of the device. A power line is understood to be a line via which the electrical energy that is supplied to the battery cells or discharged from the battery cells is transmitted.

The battery module can have a number of battery packs, each of which has a large number of battery cells, wherein the battery module control device can control and/or regulate the individual battery packs, in particular independently of one another. For this purpose, the individual battery packs can be assigned switches that can be controlled by the battery module control device. In particular, the battery module can be designed in such a way that each battery pack is assigned a battery pack control device. The battery pack control device can control the position of the switch of the respective battery pack. In addition, the battery module control device can control and/or regulate the battery pack control device in order to achieve the desired switch position and the voltage provided by the battery module.

The individual battery cells can be arranged in an interior space of a battery pack housing. The control and/or regulation of the battery packs by means of the battery module control device offers the advantage that it can be avoided that the battery module only provides the voltage of the battery pack with the lowest capacity.

Of particular advantage is a device that has the module of the device. The module of the device is the application module that can be electrically connected to the battery module. The application module can have at least one connection for connecting an electrical consumer and/or an energy supplier. Here, the application module can have the control device. In particular, the control device can be arranged in an interior space of an application module housing. This allows a compact device to be implemented. The application module can have no battery cells. Alternatively, the control device can be arranged in the battery module.

The device can have the battery module. The battery module can be electrically connected to the application module. In order to connect the battery module to the application module, in particular electrically and mechanically, the battery module can be placed on the application module. At least one other battery module can be placed on the battery module for, in particular, electrical and mechanical connection. The device can also have more than two battery modules. As a result, a device is obtained in which the individual modules are placed one above the other, in particular in the form of a stack. Alternatively, it is possible that the individual modules are not arranged one above the other but next to one another in a horizontal direction and are electrically connected to one another.

The number of modules depends on the application of the device and/or on the electrical power to be delivered by the device and/or the amount of energy required. In particular, the number of battery modules used depends on the electrical power to be delivered by the device and/or the required amount of energy. Each battery module can be releasably electrically connected to at least one module, in particular exactly two modules. The battery module can be releasably electrically connected to the application module and another battery module. Alternatively, the battery module can be releasably electrically connected to two other battery modules.

In a special embodiment, the connection section can be arranged on a housing side of the battery module. The battery module can have a number of connection sections. For example, the battery module can have a first connection section for connecting, in particular electrically and/or mechanically, the battery module to the module of the device, in particular the application module or another battery module. Here, several connection sections can be arranged on the same side of the housing. In addition, the battery module can have a second connection section for connecting, in particular electrically and/or mechanically, the battery module to another battery module of the device. Here, a plurality of second connection sections can be arranged on the same side of the housing.

The second connection section can have at least one data line of the battery module and the activation line of the battery module, wherein when the battery module is electrically connected to the other battery module, the data line can be electrically connected to the other battery module before the activation line. The second connection section can additionally have at least one power line of the battery module, which can be electrically connected to a power line of the other battery module, in particular at the same time as the electrical connection of the data line of the battery module to the data line of the other battery module.

The first connection section can be arranged on one side of the housing of the battery module and the second connection section can be arranged on another side of the housing of the battery module. In particular, the second connection section can be opposite the first connection section in the direction in which the battery module is coupled to the module of the device. The coupling direction is understood to mean a direction along which the battery module is moved in order to establish the electrical connection with the module of the device, in particular the application module. As a result, the above arrangement of the first and second connection sections on different sides of the housing means that the battery module can easily be coupled to the module of the device and/or the other battery module in a stacked design.

In a special embodiment, when the battery module is electrically connected to the module of the device, the battery module can be switched from the idle state to a determination state in which a master control device is determined. Here, the battery module can be in the determination state when the activation line of the battery module is electrically connected to the activation line of the module of the device. The transition from the idle state to the determination state can take place automatically. In the determination state, there is no longer a risk that the power line is accidentally touched by the user, so there is no risk of injury to the user.

After electrically connecting the activation line of the battery module to the activation line of the module of the device, in particular of the application module, an activation message can be transmitted to the battery module control device. It is possible that the activation message is retransmitted with a time delay from the transmission. The transmission of the activation message can be initiated by the control device.

After receipt of the activation message by the battery module control device, it can be checked whether another battery module control device that functions as a master control device exists. This makes it possible to ensure in a simple manner that the device has only one single master control device. The master control device can control and/or regulate a slave control device. Thus, the master control device can decide on the voltage provided by the device and the slave control devices follow the decision, if possible. The battery cells of the battery module and of the other battery module can be switched in parallel on the power line. Here, slave control devices are all remaining other battery module control devices of the other battery modules.

After receiving the activation message, the battery module control device can check whether another battery module control device that functions as a master control device exists. This can be done by the battery module control device checking whether a master control device has transmitted a master data element via the data line of the battery module.

Here, the battery module control device can transmit a data element via the data line of the battery module if no master control device is present. This can occur when the battery module control device has determined in a previous step that no master data element is being transmitted via the data line of the battery module.

The battery module control device may determine whether it is a master control device, depending on the data element. The data element can contain information about the address of the battery module control device. In addition, the other battery module control device can transmit a data element, in particular information about the address of the other battery module control device, via the data line. Thus, all battery module control devices receive the address of all battery module control devices. Here, the battery module control device with the smallest address can be specified as the master control device. As a result, it can be easily determined whether the battery module control device is functioning as the master control device.

After a master control device is set, the master control device may assign an identification number to the battery module control device when the battery module control device is not functioning as a master control device. Alternatively, the master control device may assign an identification number to at least one other battery module control device of another battery module when the battery module control device functions as a master control device.

In addition, the control device can transmit a control and/or regulation command for controlling and/or regulating the battery module to the battery module control device when the battery module control device is the master control device. The battery module control device can transmit a control and/or regulation command for controlling and/or regulating the other battery module to the other battery module control device when the battery module control device is the master control device. As already described above, the master control device can control and/or regulate the slave control device or slave control devices based on the command received from the control device.

In a special embodiment, the battery module can be switched to an operating state, in particular after the master control device has been determined. In the operating state, electrical energy can be supplied to the battery module for storage or can be discharged from the battery module for delivery to a consumer.

When the battery module is switched to the operating state, the battery module control device can control the battery cells in such a way that a predefined voltage value is present on the power line of the battery module. This ensures in a simple manner that the battery module provides the specified electrical voltage.

In a particular embodiment, when the electrical connection between the battery module and the module of the device, in particular the application module, is released, the electrical connection between the activation line of the battery module and the activation line of the module of the device can be separated first. In addition, the battery module control device can control the battery cells in such a way that no voltage is present on the power line of the battery module. This can prevent the user from receiving an electric shock when removing the battery module. The battery module can then be switched from the operating state to the idle state. The transfer to the idle state can take place automatically.

The master control device can be determined again when the battery module control device of a remote battery module functions as the master control device. The master control device can be determined in the manner described above. The renewed determination of the master control device ensures that the device has a master control device at all times.

In a particular embodiment, prior to connecting the other battery module to the battery module, the other battery module may be in an idle state in which no electrical energy is output from the other battery module and/or in which no electrical energy is supplied to the other battery module. The transfer of the other battery module into the operating state can take place analogously to the battery module.

Here, the other battery module control device can function as a slave control device if the device has a master control device. In particular, the other battery module control device may determine that it is a slave control device when the device has a master control device. The master control device can assign an identification number to the other battery module control device.

In a special embodiment, the other battery module control device can determine a voltage present on a power line of the other battery module. The other battery module control device can electrically connect the battery cells to the line of the other battery module if a predetermined voltage can be provided by the battery cells.

The subject of the invention is shown schematically in the figures, wherein elements that are the same or have the same effect are usually provided with the same reference symbols. Here:

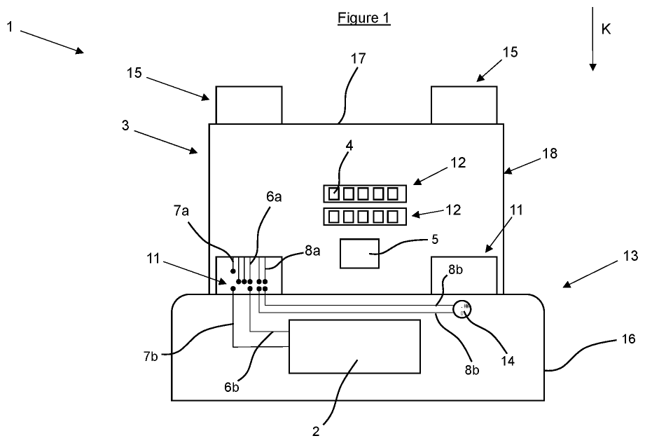

FIG. 1 shows a representation of an application module and a battery module of the device,

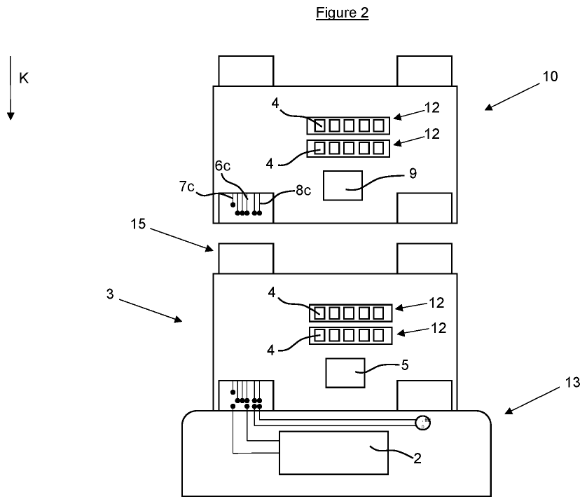

FIG. 2 shows a representation of the application module, the battery module and another battery module of the device,

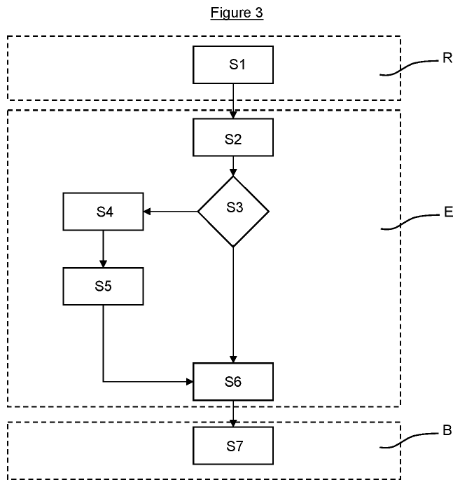

FIG. 3 shows a flow chart for the operation of the device.

A device 1 shown in FIG. 1 for supplying or discharging electrical energy has a battery module 3, which is placed on a module of the device 1, which corresponds to an application module 13 in the illustrated embodiment. The application module 13 has a control device 2. The battery module 3 has a plurality of battery cells 4 and a battery module control device 5 for controlling and/or regulating the battery cells 4. The battery module 3 is electrically connected to the application module 13 in a detachable manner. The control device 2 controls or regulates the battery module control device 5.

The application module 13 has an electrical connection 14, by means of which the application module 13 can be electrically connected to a consumer, not shown. Here, the device 1 delivers electrical energy to the consumer. Alternatively, the electrical connection 14 can be electrically connected to an energy supplier. Here, the device 1 is supplied with electrical energy that is stored in the battery cells 4.

The electrical connection 14 is electrically connected to power lines 8b. In particular, electrical energy can be supplied to the electrical connection 14 or removed from the electrical connection 14 by means of the power lines 8b. The control device 2 is electrically connected to a data line 6b and an activation line 7b. The power lines 8b, the data line 6b and the activation line 7b can be electrically connected to corresponding lines of the battery module 3 at one end.

The battery module 3 has a plurality of battery packs 12, each containing a plurality of battery cells 4. In addition, the battery module 3 has a battery module control device 5 for controlling and/or regulating the battery pack 12, in particular the battery cells.

The battery module 3 has a plurality of first connection interfaces 11 of the same design for the respective electrical connection of the battery module 3 to the application module 13, and a plurality of second connection interfaces 15 of the same design for the respective electrical connection of the battery module 3 to another battery module 10 shown in FIG. 2. The application module 13 has correspondingly shaped counter-connection interfaces for mechanical and electrical connection to the first connection interfaces 11 of the battery module 3.

The first connection interface 11 has a recess and the second connection interface 15 has a protrusion protruding from a housing side 17 of a battery module housing 18. The first and second connection interfaces 11 and 15 are arranged on different housing sides of the battery module housing. Here, the connection interfaces are opposite one another with respect to a coupling direction K of the battery module 3.

The coupling direction K corresponds to the direction along which the battery module 3 is moved to implement the electrical connection to the application module 13. To couple the battery module 3 to the application module 13, the battery module 3 is moved along the coupling direction K relative to the application module 13.

The first connection interface 11 has an activation line 7a, a data line 6a and power lines 8a, wherein only one connection contact of the activation line 7a, the data line 6a and the power line 8a is shown in FIG. 1. The data line 6a and the activation line 7a are designed in such a way that when the battery module 3 is electrically connected to the application module 13, the data line 6a is connected to the data line 6b of the application module 13 before the activation line 7a of the battery module 3 is connected to the activation line 7b of the application module.

FIG. 2 shows an illustration of the application module 13, the battery module 3 and another battery module 10 of the device 1. Here, the other battery module 10 is not electrically connected to the battery module 3.

The other battery module 10 is moved along the coupling direction K relative to the battery module 3 for electrical connection to the battery module 3. The other battery module 10 has another battery module control device 9 and is designed identically to the battery module 3. FIG. 2 also shows only one connection contact of another activation line 7c, another data line 6c and another power line 8c.

FIG. 3 shows a flow chart for the operation of the device 1. If electrical energy is to be delivered by means of the device 1, in particular via the electrical connection 14 of the application module 13, the battery module 3 is placed on the application module 13 in a first step S1.

When electrically connecting the battery module 3 to the application module 13, the battery module is switched from an idle state R to a determination state E. In the determination state E, a master control device is determined. For this purpose, in a second step S2 the control device 2 transmits an activation message to the battery module control device 5. However, this only occurs after the activation line 7a of the battery module has been electrically connected to the activation line 7b of the application module.

In a third step S3, the battery module control device 5 checks whether there is a control device that functions as a master control device. For this purpose, it is checked whether a data element is transmitted via the data line 6a.

In the event that no master control device is present, the battery module control device 5 transmits a data element via the data line 6a of the battery module in a fourth step S4. In a fifth step S5, the data element is used to determine whether the battery module control device 5 functions as a master control device.

In a sixth step S6, the master control device assigns an identification number to another battery module control device. Since the device has only the battery module 3, the step is skipped.

The battery module is then switched to an operating state B. For this purpose, in a seventh step S7, the battery module control device 5 controls the battery cells 4 in such a way that a predetermined voltage value is present on the power line 8a of the battery module 3. From this point in time, electrical energy can be taken from the battery module 3 or supplied to the battery module 3 via the electrical connection 14.

Here, the control device 2 communicates exclusively with the master control device.

If the voltage provided by the device 1 is not sufficient, the other battery module 10 is placed on the battery module 3 and the steps S1 to S7 described above are carried out again.

In the fourth step S4, the other battery module control device 9 also transmits a data element via the data line 6c of the other battery module 10. In the fifth step S5, it is determined on the basis of the data items whether the battery module control device 5 or the other battery module control device 9 functions as the master control device.

In the sixth step S6, the master control device assigns an identification number to the remaining battery module control device.

### LIST OF REFERENCE NUMERALS

1 Device for supplying or discharging electrical energy

2 Control device

3 Battery module

4 Battery cells

5 Battery module control device

6a Data line of the battery module

6b Data line of the device

6c Data line of the other battery module

7a Activation line of the battery module

7b Activation line of the device

7c Activation line of the other battery module

8a Power line of the battery module

8b Power line of the device

8c Power line of the other battery module

9 Other battery module control device

10 Other battery module

11 First connection section

12 Battery pack

13 Application module

14 Electrical connection

15 Second connection section

16 Application module housing

17 Housing side of the battery module

18 Battery module housing

B Operating state

E Determination state

K Coupling direction

R Idle state

1-47. (canceled)

48. A battery module with a plurality of battery cells, comprising:
a battery module control device for controlling and/or regulating the plurality of battery cells, wherein:
the battery module has a plurality of connection sections for a releasable electrical connection of the battery module to modules of a device for supplying or discharging electrical energy;
the battery module has a first connection section for the releasable electrical connection of the battery module to a module of the device;
the battery module has a second connection section for the releasable electrical connection of the battery module to another module of the device having another battery module;
and wherein:
the battery module control device can be controlled and/or regulated by a control device of the device;
the connection section has at least one data line of the battery module and one activation line of the battery module; and
the data line of the battery module and the activation line of the battery module are designed in such a way that when the battery module is electrically connected to the module of the device, the data line of the battery module can be electrically connected before the activation line of the battery module to the module of the device.

49. The battery module according to claim 48, wherein the connection section has at least one power line of the battery module, which can be electrically connected to a power line of the module of the device at the same time as the electrical connection of the data line of the battery module to a data line of the module of the device.

50. The battery module according to claim 48, wherein the connection section is arranged on a housing side of the battery module.

51. The battery module according to claim 48, wherein the module of the device is an application module having at least one electrical connection for connecting an electrical consumer and/or an energy supplier, and wherein the first connection section releasably electrically connects the battery module to the application module.

52. The battery module according to claim 48, wherein:
a. the second connection section has the at least one data line of the battery module and the activation line of the battery module, wherein during the electrical connection of the battery module to the other battery module, the data line can be electrically connected to the other batter module before the activation line and wherein:
b. the second connection section has at least one power line of the battery module, which can be connected to a power line of the other battery module at the same time as the electrical connection of the data line of the battery module to the data line of the other battery module.

53. The battery module according to claim 48, wherein:
a. the first connection section is arranged on one side of a housing of the battery module and the second connection section is arranged on another side of the housing of the battery module and wherein:
b. the second connection section is opposite the first connection section in a coupling direction of the battery module to the module of the device.

54. The battery module according to claim 48, wherein before connecting the battery module with a module of the device, the battery module is in an idle state in which no electrical energy is output from the battery module and/or in which no electrical energy is supplied to the battery module.

55. A device for supplying or discharging electrical energy with an application module which has at least one electrical connection for connecting an electrical consumer and/or an energy supplier and which can be electrically connected to the battery module according to claim 48.

56. The device according to claim 55, wherein the application module has the control device.

57. The device according to claim 55, wherein the device has the battery module.

58. The device according to claim 55, wherein the device has at least one other battery module which is placed on the battery module.

59. The device according to claim 55, wherein after an electrical connection of the activation line of the battery module to the activation line of the application module, the control device causes an activation message to be transmitted to the battery module control device.

60. The device according to claim 55, wherein the battery module control device, after receiving an activation message, checks whether another battery module control device exists that acts as a master control device.

61. The device according to claim 55, wherein the battery module control device checks whether a master control device transmits a master data element via the data line of the battery module.

62. The device according to claim 55, wherein the battery module control device transmits a data element via the data line of the battery module if no master control device is present.

63. The device according to claim 55, wherein the battery module control device determines whether it is a master control device depending on a data element.

64. The device according to claim 55, wherein when the battery module is switched to an operating state, the battery module control device controls the battery cells in such a way that a predetermined voltage value is present on a power line of the battery module.

65. The device according to claim 55, wherein the other battery module control device determines that it is a slave control device if the device has a master control device.

66. The device according to claim 55, wherein the other battery module control device determines a voltage present on a power line of the other battery module.

67. The device according to claim 55, wherein the other battery module control device electrically connects the battery cells to the other line of the other battery module if a predetermined voltage can be provided by the battery cells.

68. The device according to claim 55, wherein:
a. the control device transmits a control and/or regulation command for controlling and/or regulating the battery module to the battery module control device when the battery module control device acts as a master control device and/or wherein:
b. the battery module control device transmits a control and/or regulation command for controlling and/or regulating the other battery module to the other battery module control device if the battery module control device is the master control device.
